(19) United States
(12) Patent Application Publication
(10) Pub. No.: US 2015/0025425 A1
(43) Pub. Date: Jan. 22, 2015

(54) Medical Vest for High Frequency Chest Wall Oscillation (HFCWO) System

(71) Applicant: Barrett Reed Mitchell, Fayence (FR)

(72) Inventor: Barrett Reed Mitchell, Fayence (FR)

(21) Appl. No.: 14/358,661

(22) PCT Filed: Nov. 15, 2012
(86) PCT No.: PCT/EP2012/072801

§ 371 Date: May 15, 2014

(30) Foreign Application Priority Data
Nov. 15, 2011 (EP) 11306490.1

(51) Int. Cl. A61H 1/00

(52) U.S. Cl. CPC A61H 1/008; A61H 2201/0103
USPC 601/96

(57) ABSTRACT

Medical vest for High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, characterized in that the device is configured to essentially expand along one single direction when passing from the deflated configuration to the inflated configuration.

### TECHNICAL FIELD

The invention relates in general to a medical device applying repetitive compressions to the body of a human helping her/him to loosen mucus from the lungs and trachea, improve the blood circulation and the exchanges of carbon dioxide (CO₂) and oxygen (O₂).

More specifically, the present invention relates to High Frequency Chest Compression (HFCC) therapy also known as High Frequency Chest Wall Oscillation (HFCWO) therapy systems, especially but not limited to (HFCC)/HFCWO therapy systems suitable for use in a hospital or in a healthcare facility and home care use.

Under normal conditions, the human body efficiently clears mucus from the lungs and the respiratory tract by way of coughs.

Irregularities in the normal mucociliary transport system or hyper secretion of respiratory mucus results in an accumulation of mucus in the lungs causing severe medical complications such as hypoxemia, hypercapnia, chronic bronchitis and pneumonia.

Abnormal respiratory mucus clearance is a manifestation of many medical conditions such as pertussis, cystic fibrosis, atelectasis, bronchiectasis, cavitating lung disease, vitamin A deficiency, chronic obstructive pulmonary disease (COPD), asthma, and immotile cilia syndrome. Exposure to cigarette smoke, air pollutants and viral infections also negatively affect mucociliary function. Post-surgical patients, paralyzed persons, patients suffering from neuromuscular diseases, long term care bedridden patients, and newborns with respiratory distress syndrome also exhibit reduced mucociliary transport.

Chest physiotherapy (CPT) is a well-known method for treating patients with one or more of the above health conditions.

Several methods of chest physiotherapy exist.

Traditionally, care providers perform Chest Physical Therapy (CPT) one to four times per day. CPT consists of a patient lying in one of twelve positions while a caregiver “claps” or pounds on the chest and back over each lobe of the lung. To treat all areas of the lung in all twelve positions requires pounding for half to three-quarters of an hour along with inhalation therapy. CPT clears the mucus by shaking loose airway secretions through chest percussions and postural draining of the loosened mucus toward the mouth. Active coughing is required to ultimately expectorate the loosened mucus. CPT requires the assistance of a trained caregiver, often a family member if a nurse or respiratory therapist is not available. It is a physically exhausting process for both the CF patient and the caregiver.

Artificial respiration devices for applying and relieving pressure on the chest of a person have been used to assist lung breathing functions, by loosening and helping the elimination of mucus from the lungs of persons with cystic fibrosis (CF). These devices use jackets having air accommodating bladders that surround the thorax of the patient. The bladder worn around the thorax of the CF patient is constantly inflated and compresses the thorax, the flow of air into the bladder is then cut/interrupted repeatedly which alternatively compresses and releases of the thorax at frequencies as high as 25 cycles per second. Each compression produces a rush of air through the lobes of the lungs that shears the secretions from the sidewalls of the airways and helps move them toward the larger central bronchial airways where they can be expectorated by normal coughing.

One of the most efficient treatments is High Frequency Chest Compression (HFCC) therapy also known as High Frequency Chest Wall Oscillation (HFCWO) also commonly referred to as airway clearance jackets or vests. Treatments using (HFCC)/HFCWO are well-known in the art.

Existing solutions describe a vest connected to a pulsed air generator via a tube. The entrance of the tube in the vest is reversible so the generator can be positioned on both sides of the vest while in use. So the vest receives pulsed air that inflates and deflates it. This helps the mucociliary transport activity. However, any further increase of efficiency of these systems would be very advantageous.

Therefore, enhanced systems have been developed. An enhanced system provides a plurality of compartments that can be independently inflated.

Thus, treatment can be customized. For instance, this allows customizing the frequency of strokes according to each part of the chest.

This also enables to use a HFCWO vest with post-surgical patients having respiratory distress syndrome. The area that is still healing from the surgery does not receive strokes from the compartments while the other areas receive the necessary HFCWO treatment.

While some developments have enhanced efficiency of HFCWO treatments, existing solutions still present drawbacks that limit efficiency of treatments. In particular, in order to efficiently shear the secretions from the sidewalls of the lungs and airways, existing systems generate important compressions to the patient's chest and use a high constant background pressure which can cause significant discomfort and even changes in patient vital statistics, e.g. blood pressure, heart rate. These compressions are sometimes painful and often lead to reduction of the time and therefore the efficiency of each sequence of treatment. Additionally, it has turned out that in some cases, the patients are reluctant to do their treatment because of the severe discomfort including nausea, difficulty breathing, sense of claustrophobia and even pain. Healing improvement is therefore limited, or it takes a longer period, or in some cases the patient's condition deteriorates due to lack of appropriate or patient tolerable therapy.

Therefore, the objective of the present invention is to enhance the efficiency of existing treatments involving medical system applying repetitive compressions to the body of a human.

### SUMMARY

The foregoing and other objectives are fulfilled at least partially, and other advantages are realized, in accordance with the embodiments of this invention.

The invention relates to a medical vest for focused pulsation High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, characterized in that the device is configured to essentially expand along one single direction when it repetitively passes from the deflated configuration to the inflated configuration.

According to another embodiment, the invention relates to a medical vest for High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, wherein the device is configured to essentially expand along one single direction when passing from the deflated configuration to the inflated configuration and wherein the device comprises a body forming at least a part of the chamber, the body comprising bellows arranged for automatically decreasing the length of the body and bringing the device back to its deflated configuration when the chamber is not supplied with pressurized air.

According to another embodiment, the invention relates to medical vest for High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, wherein the device is configured to essentially expand along one single direction when passing from the deflated configuration to the inflated configuration and wherein the device comprises a body forming at least a part of the chamber, the body comprising bellows arranged for automatically decreasing the length of the body and bringing the device back to its deflated configuration when the chamber is not supplied with pressurized air, the device comprising the body, a head configured to deliver a therapeutic pulsation to the body of the patient during usage, and a base, the body extending between the base and the head, wherein the base comprises at least: an inlet port for feeding the chamber with pressurized fluid and at least an outlet port for communication between the chamber and a valve.

With the device of the invention, the deformation of the device when it expenses is high according to one direction and is null or low according to the other directions. The device acts as an air piston having a head that operates repetitive translations to transfer focused pulsations to the patient's body. Contrarily to existing systems, the device does not significantly expand along directions that are transverse to the one of the patient chest wall. The force generated by the inflation of the device can therefore be focused on the areas of the patient that are relevant for an efficient treatment. All, or at least almost all pressure provided in the chamber contributes to generate a useful force, also referred to as therapeutic pulsation, for the patient. Therefore, the invention allows a reduction of the overall pressure to be provided to the chamber while increasing or maintaining the amplitude of the force applied in a direction substantially perpendicular to the patient's body.

In existing systems the pressure provided to each chamber of a HFCWO system generates important compressions that are at the very least uncomfortable and that are most of the time painful (it seems that pulses are not in themselves painful but the constant compression is very uncomfortable) and stressing. Yet, it has turned out that because of that lack of comfort and that potential pain and stress, patients often reduce the time of the treatment, do it less often or even interrupt it, leading thereby to a non optimal efficiency of the treatment. In some cases, this also leads to further costly medical interventions due to exacerbations of condition.

In addition, the operation of the medical vest according to the present invention has no or has a low effect on patient's blood pressure as the existing devices do. Existing devices must carry warning labels and are not suitable for hypertensive, or potentially hypertensive, patients which restricts the range of uses and patients. The invention allows therefore enlarging the range of uses and of patients.

With the existing systems, the noise generated by the compression device feeding the chambers with air is very loud, more than 70 decibels, which prevents the patient (and also those around them) from doing other activity such as reading, working, talking, listening to music. This also makes use in certain clinical environments not possible further reducing patient use. This device according to the invention operates at 62 decibels, which is almost 8 to 10 times less noisy. In addition to being very uncomfortable and potentially painful and stressful, current HFCWO treatments are therefore very boring. As the device according to the invention allows reducing the necessary pressure, the noise generated through the compression device is significantly decreased. Patients can therefore use the invention while doing other activities. Additionally, the invention allows using a HFWCO vest in a room where other people/patients are present. This feature of the invention is particularly advantageous since patients can therefore be treated in their health care facility room which is much simpler and cheaper than having a room dedicated to such treatment.

Through all these advantages, it appears clearly that the invention will result in a therapy that is more efficient and gentler for patients and at the same time greatly increasing the range of clinical applications and potential patients who could benefit from HFCWO therapy who cannot today due to limitations of existing devices. Clinicians estimate the range of clinical applications and patients will increase four to six times due to more controllable patient ‘friendly’ delivery system, much lower noise levels, but most importantly the ability to focus the pulsations to specific parts of the thorax allowing adjustments to therapy to meet individual patient's needs and clinical restrictions. The clinicians also feel the increased patient comfort from the massage like effect will greatly increase adhesion to and compliance with therapy regimes greatly increasing the efficiency and reducing exacerbations resulting in hospitalization.

Another aspect of the invention relates to a High Frequency Chest Wall Oscillation (HFCWO) system comprising a medical vest according to any one of the preceding features and comprising means for delivering a pressurized fluid to the device. Therefore, the invention also relates to a medical apparatus that incorporates the vest housing the device and that allows providing a HFCWO treatment.

Optionally and preferably, at least some of the devices are independently provided with a pressurized fluid. Each zone of the patient's body can therefore be provided with strokes or focused pulsations having specific frequencies and amplitudes. The treatment can be more efficient. In addition, this allows for not applying any strokes/focused pulsations to any zones of the body that are painful or that are recovering from a trauma or surgery.

According to another aspect, the invention relates to an inflatable device for applying repetitive focused pulsations or compressions on a patient's body, comprising at least a deformable chamber and at least a port in communication with the chamber configured to let a pressurized fluid flowing alternatively in and out the chamber so that the inflatable device alternatively passes from an inflated configuration to a deflated configuration, characterized in that the device is configured to essentially expand along one single direction when alternatively passing from an inflated configuration to a deflated configuration.

Another aspect of the present invention relates to a medical apparatus, for instance a garment or a stripe (wrap or band) to be worn, applied or attached on a chest, leg or arm and comprising a device according to any one of the above features. In addition, the medical apparatus is configured to be coupled with means for pressurizing the device. This can also be used as a Pad placed under a patient to avoid all the problems of getting a Vest or Wrap around the entire thorax of a patient in intensive care who is connected to various medical monitoring devices, ECG in particular, who can still benefit from the therapeutic pulsations over the entire rear of the thorax, thereby aiding the earliest clearance of the lungs and release from Intensive Care.

According to another aspect, the invention provides a method for treating a part of the body of a patient, where a medical apparatus comprising at least a device according to any one of the above features is placed in the vicinity of the body of the patient. The method comprising a step of repetitively applying a pressure into the chamber of the device so that the device alternatively passes from an inflated configuration to a deflated configuration, generating thereby pulsations onto the patient's body. As it will be detailed below, the method according to the invention enhances the efficiency of the treatment while allowing the reduction of the pressure constantly applied on the patient's body. It has been identified that the constant pressure applied onto the patient's body with the existing methods has a negative effect on the breathing and on the blood pressure and potentially other important physiological functions.

According to another aspect, the invention provides a method for treating a part of the body of a patient, where the treatment involves using a medical apparatus comprising an inflatable device as described above.

### BRIEF DESCRIPTION OF THE DRAWINGS

The foregoing and other aspects of the embodiments of this invention are made more evident in the following Detailed Description, when read in conjunction with the attached Drawing Figures, wherein:

FIG. 1 is a schematic illustration of a medical vest according to an embodiment of the invention, said HFCWO system comprising a plurality of devices.

FIG. 2 shows a perspective view of an example of device for HFCWO system according to an embodiment of the invention.

FIG. 3 is a side view of the device according to FIG. 2.

FIG. 4 is a cross sectional view of the device according to FIG. 2.

FIG. 5 is a perspective view, partly sectioned, of the device according to FIG. 2 in a deflated configuration.

FIG. 6 is a perspective view, partly sectioned, of the device according to FIG. 2 in an inflated configuration.

FIG. 7 is a schematic illustration of a part of an example of HFCWO system according to an embodiment of the invention, said HFCWO system comprising a plurality of devices.

### DETAILED DESCRIPTION

Some advantageous features and steps will be described below. Then some exemplary embodiments and use cases will be further detailed in regard with the drawings.

In the present invention a patient designates a person or an animal that receives a treatment.

Before describing with details an embodiment of the present invention, some advantageous features will be mentioned. These features can be taken independently or in combination.

It is first recalled that according to an aspect, the the invention relates to a medical vest for (focused pulse?) High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, characterized in that the device is configured to essentially expand along one single direction when it repetitively passes from the deflated configuration to the inflated configuration.

Optionally, the medical vest according to the invention may comprise at least one of the facultative and advantageous features below.

The device comprises elastic means configured to pass from a released position to a deformed position enabling thereby the medical vest to apply repetitive compressions (focused pulsations?) to the body of a human.

Said single direction is preferably a direction that is substantially perpendicular to the patient's body. Thus, each inflation of the device generates a focused pulsation or strokes having a force that is fully or at least mainly transmitted to the patient's body.

In the inflated configuration the elastic means are in a deformed position. In the deflated configuration the elastic means are in a release position.

The elastic means comprise at least a return spring. The device is configured so that it is deflated when the return spring is in a released position and so that it is inflated when the return spring is in an extended position.

The device comprises a body forming at least a part of the chamber, the body comprising the elastic means and being arranged to expand along said one single direction when the device passes from the deflated configuration to the inflated configuration.

The body is arranged to retract along a transverse direction also designated radial direction, which is substantially perpendicular to said one single direction when the device passes from the deflated configuration to the inflated configuration.

The length of the device increases and its width decreases when passing from the deflated configuration to the inflated configuration. The length is the dimension taken according to the direction of the axial deformation of the device. The width is the dimension taken according to the direction of the transverse deformation of the device. Preferably, when the device has a substantially cylindrical shape, its width corresponds to the maximal outer diameter of its body. The length of the device decreases and its width increases when passing from the inflated configuration to the deflated configuration.

Preferably, the variation of length between the deflated and inflated configurations is higher than the variation of width.

According to a preferred embodiment, the body is arranged to expand along a transverse direction that is substantially perpendicular to said one single direction and to retract along said single direction when the device passes from the inflated configuration to the deflated configuration.

Preferably, the body is made of a material that has a low elasticity at the pressures applied during use. Typically, the pressures inside the chamber do not exceed 350 millibars and are usually comprised between 100 and 350 millibars. However, the body can elastically deform according to a main direction. This direction corresponds to the longitudinal/axial direction of the body.

According to an advantageous embodiment, the body comprises bellows arranged for automatically decreasing the length of the body and bringing the device back to its deflated configuration when the chamber is not supplied with pressurized air. Thus the device is elastic thanks to its shape, i.e., thanks to the bellows. Preferably, the elasticity is not mainly brought by the elastic properties of the material forming the device.

Advantageously, the elastic means are formed by the bellows. Thus the body is arranged to form corrugations or pleats when the device is in its deflated configuration and wherein the corrugations or pleats are decreased or removed when the device is in its inflated configuration.

Preferably, once the device is in its deflated configuration, its length can still be reduced by applying a compression force on it. The body can thus be shrunken. When the compression force is released, the device passes from this shrunken configuration to its released configuration. This alleviates the compression of the patient's body when no pressurized air is supply to the chamber of the device, allowing thereby the patient the breath normally or (or to cough) quite normally.

Advantageously, the elastic means are made of silicon.

The device comprises a head configured to stroke the body of the patient during usage of the invention, a body substantially deformable along said one single direction and a base, the body extending between the base and the head.

Preferably, the head is essentially not deformable in use. Preferably, the base is essentially not deformable in use. According to a specific non limitative embodiment, the head and base are very different, the base is very thick and not deformable whereas the head is slightly deformable to adapt to contorts of the patient's thorax.

Preferably, the surface of the impact portion of the head is constant whatever is the configuration of the device: inflated or deflated. The impact portion of the head is the surface of the head that strokes the patient's body. The surface of the impact portion can be directly in contact with the patient's body or patient's garments. Preferably, the vest comprises a wall, between the head of the device and the patient's body.

The material is substantially inelastic in use but the device, thanks to its shape that incorporates bellows is elastic. The respective thicknesses of the various parts of the device also allow controlling the parts that do deform and the parts that do not deform during the use.

Preferably, the body is made of silicon, but differing thicknesses in different parts allow for deformation or resist deformation. For example the base is very thick and is hardly deformable whereas the sidewalls are thin and easily deformable and flexible allowing for the bellows effect.

The head in contact with the patient is slightly thicker to ensure maximum transmission of energy to the thorax of the patient whilst still remaining flexible enough to be comfortable for the patient. Thus, the elasticity of the device is mainly provided by the shape of the device, i.e. the bellows, and not mainly by the intrinsic elasticity of its material.

Thus, a non limitative feature of the invention is that the body is made of a material that is substantially inelastic during use, the elasticity of the device being mainly enabled by the shape of the elastic means.

Advantageously, the base comprises the at least one port. Preferably, the chamber is formed by the body, the head and the base.

According to an advantageous embodiment, the head and the body are made of silicon.

Advantageously, the head and the body are made of a single part. Thus the device is monolithic. The device is therefore made of a simple part which provides an increased robustness. Yet, robustness is an important aspect of the invention since the HFCWO system undergoes a very high number of compression and de-compression cycles. The cost of a medical vest according to the invention is also limited thanks to the device incorporated in the vest.

Advantageously, the body is attached on the base so that the chamber is sealed.

Preferably, the base is made of silicon with a thickness sufficient to be non-deformable.

Preferably, the body and base are both obtained by means of rubber stamping or injection moulding technology. Two different molds are used to obtain the body and the base, then the two part are fixed together, typically thanks to a glue.

Advantageously, the body presents a shape substantially annular. This contributes to remove areas that could wear after a high number of repetitive inflation and deflation cycles, enhancing thereby the robustness of the device and the life span of the vest.

Advantageously, the medical vest comprises a plurality of housings, at least some of the housing comprising a device.

A housing has a first wall arranged to be in regard with the patient's body and a second wall arranged to be in regard with the outside during usage of the medical vest, the device comprising a head configured to be in contact with the first wall, a base configured to be in contact with the second wall and a body extending between the base and the head.

According to an advantageous embodiment, the devices are arranged in at least a line and preferably several lines. The lines can be substantially horizontal or vertical. (however, other configurations can be envisaged as practical for specific clinical applications, example individual pads of hand size which Drs can attach with Velcro wherever they want the therapeutic pulsations to treat specific lobes of the lungs, mimicking direct chest physical therapy)

In the present invention, a High Frequency Chest Wall Oscillation (HFCWO) system applies repetitive compressions or focused pulsations to the chest of a human or animal, the chest being either the front side of the body, either the back side of the body or either the right side or the left side of the body or being a combination of any of these zones. Thus the scope of protection of the present invention is not limited to medical vest applying repetitive compression or focused pulsations only on the front of the trunk of a human or an animal. The present invention also encompasses vests applying repetitive compressions or focused pulsations only on the back side of the chest of a human or of an animal.

A medical vest or medical garment according to an embodiment of the invention will now be described.

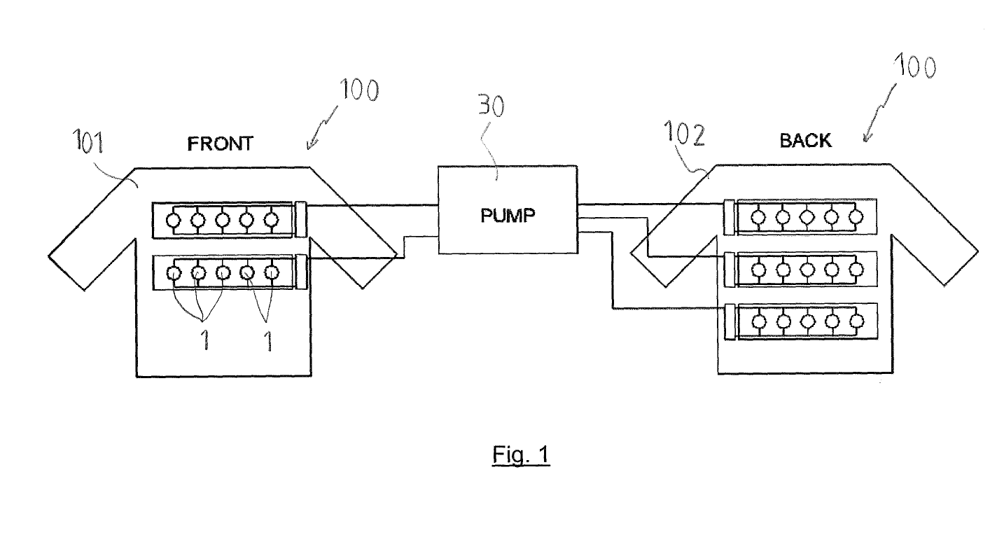

As illustrated on FIG. 1, the medical vest comprises a plurality of devices 1 located at various parts of the front 101 and back 102 of a vest 100.

A pump 30 is arranged to provide a pressurized fluid, typically air, to the device of the vest 100. To this end, ducts are connected to the pump 30 and the devices 1. When a device 1 is filled with pressurized air, it inflates and generates a stroke or focused pulsations onto the patient's body.

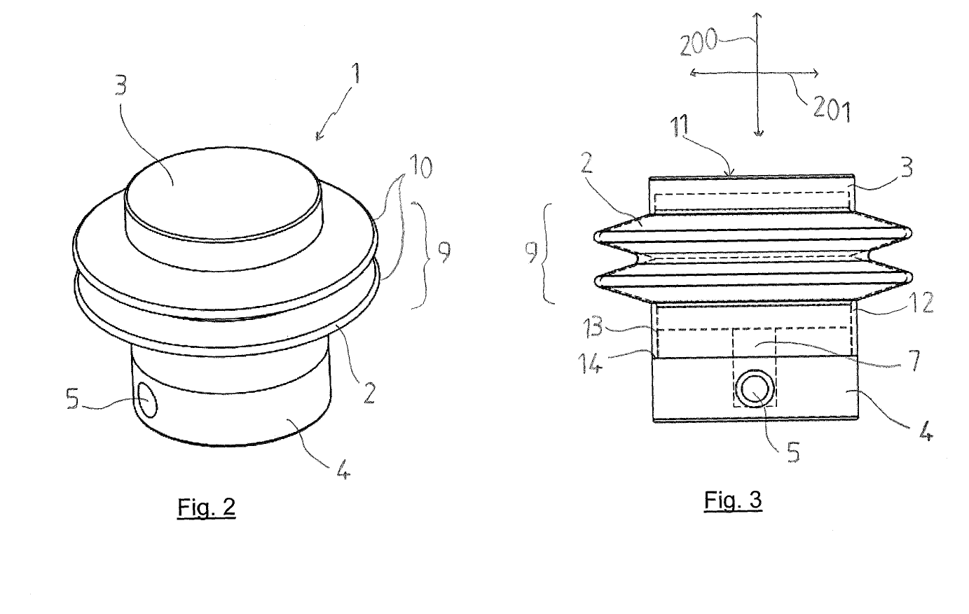

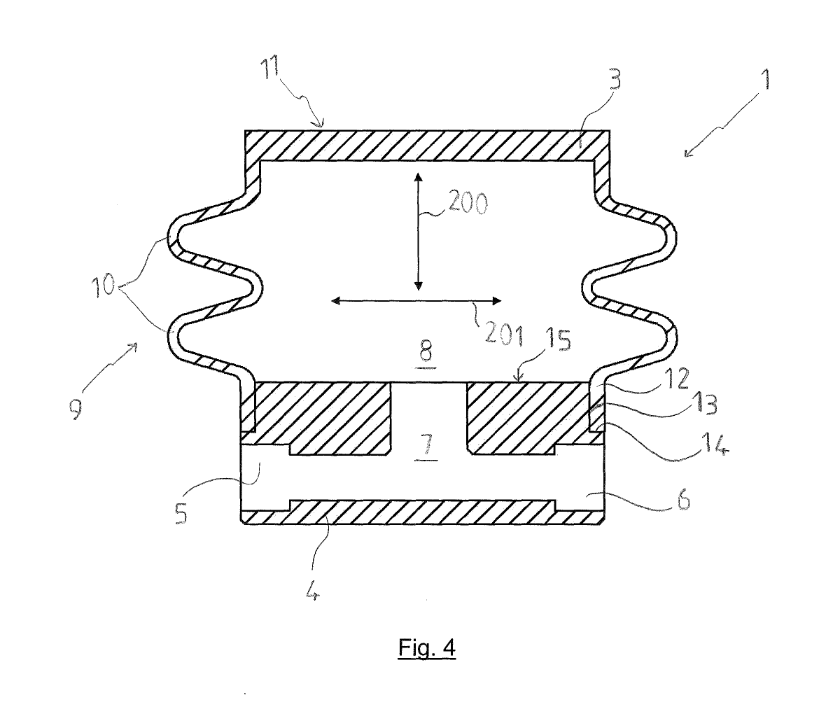

A device 1 according to the invention will be now described in reference to FIGS. 2 to 6. The device 1 comprises a chamber 8 that is sealed. At least, an opening 7, also referred to as an air inlet, allows feeding the chamber with pressurized fluid. Preferably, the same opening 7 allows emptying the chamber 8. The chamber 8 is delimited by walls of a head 3, a body 2 and a base 4.

The body 2 extends between the head 3 and the base 4.

The head 3 is configured to be, in use, turned toward the patient's body.

Preferably an external wall of the head presents a substantially flat surface which is intended to stroke/deliver a pulsation to the patient's body. This flat surface is referred to as the impact portion 11.

The base 4 comprises at least a port 5, 6 for establishing a communication between the chamber 8 and its opening(s) 7 and an air supply. In the illustrated embodiment, the base 4 comprises a first port 5 in communication with the pressurized air supply, typically the pump 30. The base also comprises an additional port 6 for communication with the exterior of the vest 100. Typically, the additional port 6 is in communication with the air at room pressure. According to a specific embodiment, the additional port 6 is connected to an inlet of a tube, an outlet of the tube equipped with a valve preferably located inside the pulsation device.

The ports 5, 6 of the base 4 are in communication with the chamber 8 through the opening(s) 7.

Advantageously, the port 6 in communication with the ambient air is sized so that it does not allow all the air flowing in the device to get directly out through it. Instead, its size allows most of the air to be retained in the chamber to inflate it and to transfer a focused pulsation on the patient's body. The feeding of the device with pressurized fluid and the expansion of the chamber until the stroke are performed in a time duration that is too short to allow the pressurized air to flow out from the port 6.

Thus it is not necessary to have a valve for stopping the air at the port 6 when the head pulses against the patient's body. Therefore, while being highly efficient, the device is much simpler and reliable. In addition, the cost of the device is significantly reduced.

In addition, the port 6 contributes to render the treatment more gentle.

Typically, the base 4 presents a shape substantially cylindrical. The ports 5, 6 extend transversally/radially inside the base 4 from an external wall of the base 4. The opening 7 extends substantially longitudinally, form the ports 5, 6 to the upper wall 15 of the base 4. Said upper wall 15 of the base defines in part the chamber 8.

The body 2 is tightly sealed to the chamber 8 and to the head 3. Preferably the head 3 and the body 2 form a single, monolithic part.

Thus a distal end of the body 2 forms the head 3. A proximal end 12 of the body 2 is attached to the base 4.

Preferably, the base 4 presents at its distal end a cylindrical section 13 that is complementary of the section of the proximal end 12 of the body 2. Typically, the two sections 12, 13 are cylindrical and the inner diameter of the proximal end 12 of the body 2 fits the outer diameter of the distal end 13 of the base 4. There is therefore a tight fit between the body 2 and the base 4.

The body 2 and the base 4 are glued together ensuring a perfect pneumatic seal of the two parts at the pressure used during operation.

The chamber 8 is thus a sealed volume except through the openings 7, said volume being defined by the upper wall 15 of the base 4, the inner walls of the body 2 and the inner wall of the head 3.

When the device 1 is fed with pressurized fluid, typically pressurized air, it inflates and is brought, from a deflated configuration to an inflated configuration.

The device 1 comprises elastic means arranged so that when the device 1 is not fed with pressurized, fluid typically air, the chamber 8 automatically retracts. The chamber 8 thus passes from an inflated configuration to deflated configuration.

The fluid supply, not detailed in the present invention but known from the person of ordinary skills, provides pulsed fluid under pressure. A particularly advantageous supply system is described in the commonly owned International patent application published with the following number WO2011086200. The supply of pulsed air generates cycles of inflations and deflations of the device 1. Each inflation generates a stroke or focused pulsation onto the patient's body.

The elastic means allow an acceleration of the movement from the inflated configuration to the deflated configuration through pulling back the head 3 toward the base 4, such as a return spring. In addition, the device 1 is configured so that when passing from the device 1 deflated configuration to the inflated configuration, the device 1 expands substantially according to a single direction 200. This direction is the axial direction 200 along which the head 3 of the device 1 performs forth and back movements. This axial direction is preferably substantially perpendicular to the area of the patient's body where the device strokes or delivers a pulsation. Almost all the energy of the stroke or pulsation is thus delivered to the patient's body, increasing thereby the efficiency of the treatment.

Therefore a relatively low volume of pressurized fluid is necessary to deliver efficient strokes or pulsations. The overall energy provided to each device 1, and consequently the overall energy provided to the vest, is thus decreased. Therefore, the overall trauma undergone by the patient is thus greatly reduced while generating controlled forces applied perpendicularly to the patient's body. This allows targeting clinically important areas of the patient's body. The vest 100 comprising such devices 1 therefore permits the transformation of all or almost all the energy delivered to the vest 100 into focused and controlled strokes and pulsations. The overall action on the patient's body is thus much gentler and more precisely targeted than with previous systems.

In addition, the operation of the medical vest has no or has a low effect on the patient's blood pressure which allow hypertensive patients to use the vest.

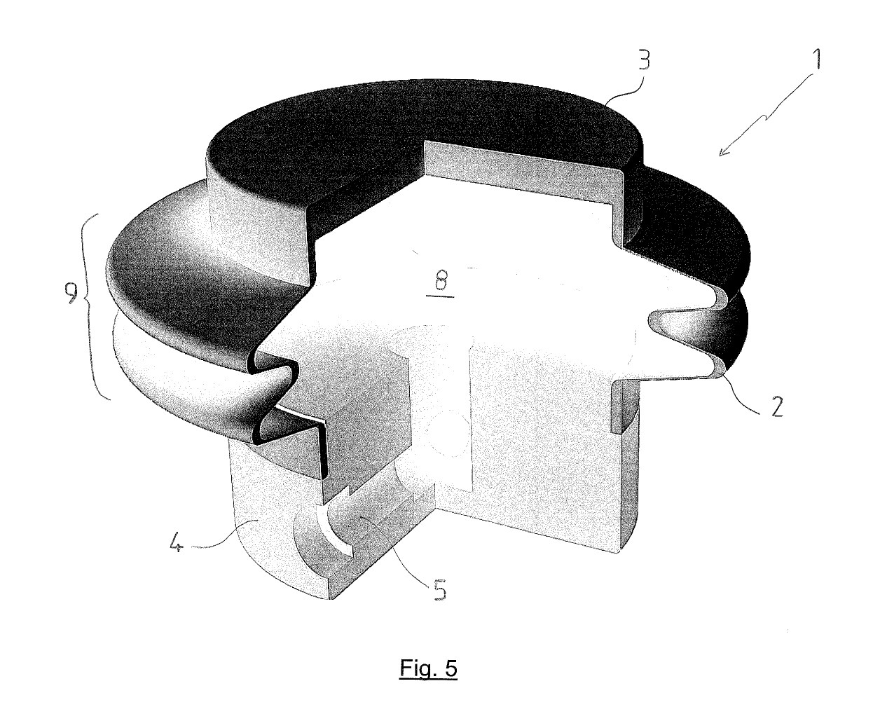

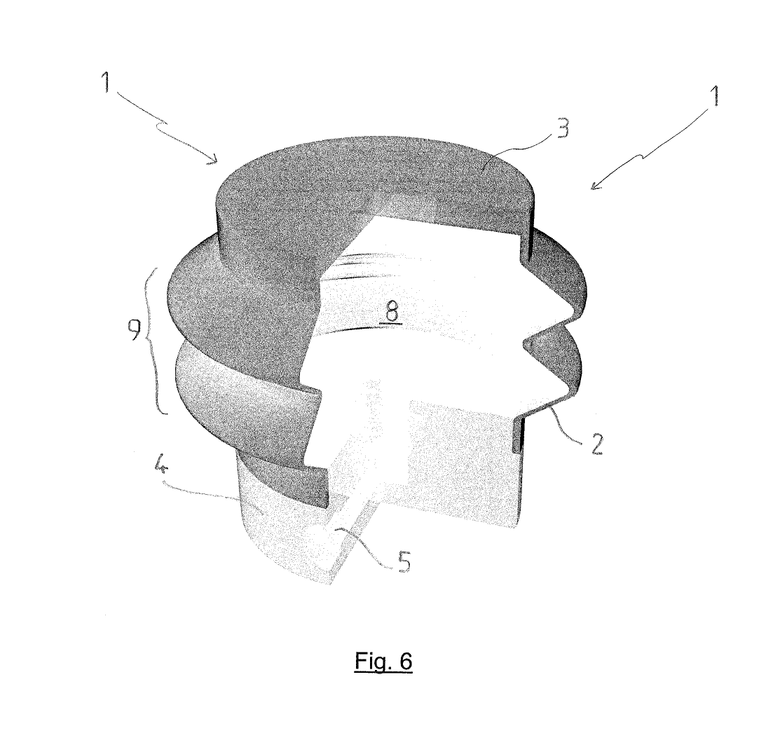

Preferably, the elastic means are comprised in bellows 9. Such bellows 9 are clearly illustrated on FIGS. 2 to 6. The bellows 9 retract when the device 1 passes from the inflated to the deflated configurations and expand when the devices passes from the deflated to the inflated configurations under the force of the pressure rising in the chamber 8. The bellows 9 tends to bring the device 1 back to the deflated configuration. It acts as a return spring. FIGS. 5 and 6 respectively illustrate bellows 9 in their retracted and expanded positions.

The device provides a higher reactivity compared to existing systems. It can efficiently operate in a wide range of frequencies, typically frequencies comprised between 5 and 40 Hz and preferably comprised between 15 Hz-40 Hz and preferably comprised between 20 Hz-30 Hz. HFCWO treatments can thus be adapted to every patients and medical situations.

Preferably, the bellows 9 comprise corrugations 10, or pleats 10 having substantially annular shapes. Thus the length of the body 2 increases along the axial direction 200 and the outer dimension, typically outer diameter, of the bellows 9, taken along the transverse direction, decreases when the device 1 inflates. The length of the body 2 decreases along the axial direction 200 and the outer dimension of the bellows 9 increases when the device 1 deflates.

The retracted position of the elastic means or bellows 9 is also a release position. However, the body 2 can be free then retracted or shrunken in case a force is applied on it. Typically, when the device 1 is compressed between two walls of the vest 100 under the pressure of the patient's body (especially when the patient breaths), the bellows 9 can further retract. This increases the comfort of the patient when breathing or coughing for instance.

The head 3 is substantially non-deformable in regard to the deformation of the body 2. In particular, the impact portion 11 does not inflate when the air pressure increases in the chamber 8. Thus the stroke or focused pulsation, its amplitude and location are perfectly controlled. The head 3 and the body 2 are made of an elastic material, typically silicon for instance, but the thickness of the head 3 makes it non-deformable under the pressures utilized. The shape of body 2 makes it non-deformable on the transverse direction. More generally, the deformation of the head 3 and body 2 through elasticity is negligible in comparison to the deformation through the extension and retraction of the bellows 9.

Preferably, the base 4 is non-deformable through elasticity during use.

While being non-deformable through elasticity during back and forth movements of the head 3, the body 2 and base 4 are preferably ductile. This notably increases the comfort of the user.

Preferably, the head 3 and body 2 are made of silicon. Preferably, the base 4 is also made in silicon. This allows increasing the robustness of the device and its ductility, providing thereby enhanced lifespan and comfort.

Preferably, the variation of dimensions according to the axial direction 200 is higher than according to the transverse direction 201. Typically, the ratio ‘transverse variation/axial variation’ is lower than 0.8. Preferably, this ratio is lower than 0.4.

Typically, during the operation of the vest, the maximal pressure inside the piston is comprised between 100 millibars (10⁻³ bars) and 350 millibars. Advantageously, during a whole cycle, the device is momentarily deflated and its internal pressure is ambient pressure or is lower than 30 millibars. Very good results have been obtained for a maximal pressure comprised between 150 millibars and 250 millibars inside the air piston. More precisely a pressure of 200 millibars provides very efficient results.

Typically, during the operation of the vest, the maximal pressure applied by the head of the device onto the patient's body is comprised between 20 millibars and 80 millibars. At each cycle, as the device is deflated, the pressure applied onto the patient's body is practically nothing, and is more generally below 2 millibars or 3 millibars. This allows the patient to breath during the treatment. Advantageously, as the pressure applied on the patient's body momentarily decreases to reach a pressure that is practically nothing or very low, then the treatment has no or very low effect on the patient's blood pressure. More precisely, during the operation of the vest, the maximal pressure applied by the head of the device onto the patient's body is comprised between 40 millibars and 65 millibars and preferably comprised between 40 millibars and 60 millibars. Typically, this pressure is 50 millibars or 58 millibars.

Advantageously, the head of the device has a thickness, according to the axial direction, that is comprised between 0.5 mm and 4 mm. During the development of the invention, it has turned out that a portion of the energy of each stroke or pulsation is not transferred to the patient's body but is instead transformed into a rebound that the device performs against the patient's body. The above values of thickness for the device's head allow reduction of this rebound effect and produce more energy into the pulsation onto patient's thorax. Thus the energy transferred into the patient's body is increased, enhancing thereby the efficiency of the treatment. More precisely, the thickness of the head of the piston is comprised between 1 mm and 3 mm. Typically, for optimum effect this thickness is 2 mm. Very good results have been obtained for a silicon made head.

Specific features of a device 1 will be now detailed. Such features do not limit the scope of the invention.

The device 1 in its release configuration has a length, according to the axial direction 200, comprised between 30 mm and 60 mm (millimeters i.e, 10⁻³ meters) and preferably approximately 44 mm.

Its length in its inflated configuration is comprised between 48 mm and 50 mm. The impact portion 11 has a surface comprised between 2900 mm² and 5500 mm². Preferably, the impact surface 11 is circular and has a diameter comprised between 25 mm and 50 mm and more preferably of 36 mm.

In its detailed configuration, the device 1 has an outer diameter, taken at the bellows 9, comprised between 35 mm and 65 mm and approximately of 50 mm.

In his inflated position, the device 1 has an outer diameter, taken at the bellows 9, comprised between 47 mm and 49 mm and approximately of 48 mm.

The base 4 has a diameter comprised between 25 mm and 50 mm and preferably of 36 mm. The height of the base 4 is comprised between 12 mm and 25 mm and preferably of 18 mm.

The diameter of the opening 7 is comprised between 5 mm and 10 mm and preferably 7.6 mm.

The diameter of the ports 5, 6 is comprised between 12 mm and 25 mm and preferably is comprised between 3 mm and 6 mm and preferably 4.7 mm.

The height of the chamber 8, in the release position, is comprised between 15 mm and 35 mm and preferably 25.3 mm.

The height of the inflated position, in the release position, is comprised between 15 mm and 35 mm and preferably 25.3 mm. The height of the chamber is taken between the upper wall 15 of the base 4 and the inner wall of the head 3.

The thickness of the impact portion 11 is comprised between 2 mm and 4 mm and preferably 3.1 mm.

The thickness of the wall of the body 2, i.e., the wall forming the bellows 9 is comprised between 0.4 mm and 1.8 mm and preferably between 0.6 mm and 1.4 mm and more preferably around 1 mm. Preferably the bellows 9 forms two corrugations 10.

The top of each corrugation 10 presents a curved surface.

The radius of the curve, in the deflated configuration is comprised between 2.0 mm and 2.5 mm. This allows to decrease the risks of shear and enhances the lifespan of the device.

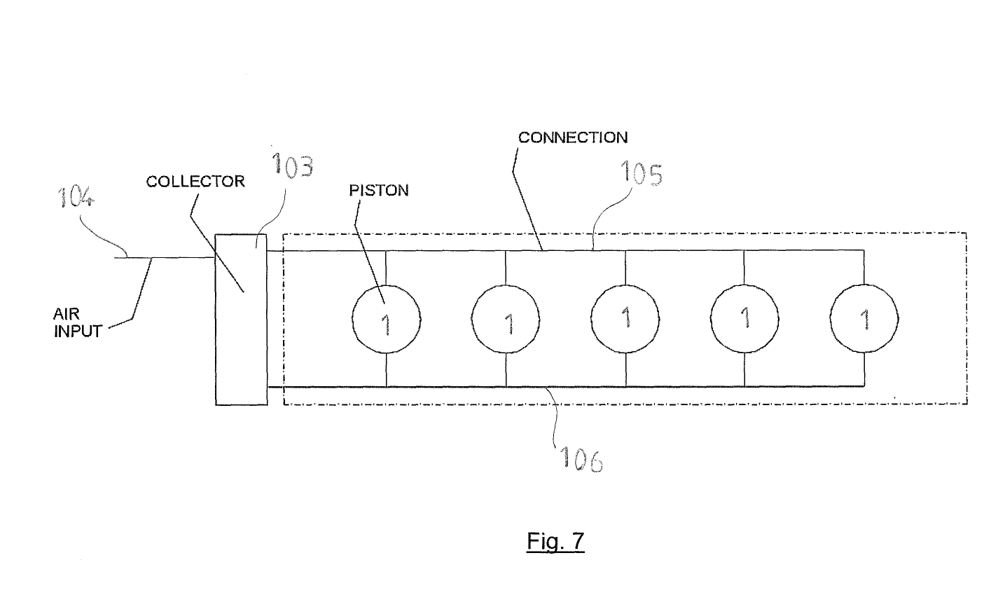

FIG. 7 illustrated an assembly of a plurality of devices 1 incorporated in a vest 100 according to the invention. Five devices 1 are connected to a collector 103 supplied with pressurized fluid through an input duct 104. In this illustrative embodiment, the five devices share the same duct 105 and 106 for supply and emptying. Thus a plurality of devices can be controlled simultaneously.

From the above description, it appears clearly that a vest 100 according to the invention allows providing more gentle and efficient treatment. In addition, the robustness and lifetime of the devices incorporated in the vest 100 are particularly good.

The foregoing description has provided by way of exemplary and non-limiting examples a full and informative description of various medical vests and systems for implementing the exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the embodiments of this invention.

Although a particularly advantageous application of the invention is a vest for HFCWO, the device according to the invention may also be part of any medical system configured to be applied on any part of the body of a person or an animal.

In particular, all the features of the medical vest for High Frequency Chest Wall Oscillation (HFCWO) system as claimed in the present invention could be combined to any garment aiming to apply repetitive compressions (or focused pulsations??) to a part of the body of a human, said part of the body being not limited to the chest. In particular, such garment including at least a device according the invention could for instance also be used for apply repetitive compressions (or focused pulsations??) to any one of the legs, the arms, the buttocks or trunk of the body of a human.

The amplitude of the pulsations generated by the a vest or a device according to the invention is several times greater than those created by existing devices which simply cut airflow into the vest causing a small dip in pressure to create the pulsations (from 58 mb down to 52 mb for the VEST) whereas the vest or the device according to the invention goes from 0 mb up to 58 mb thus giving us an amplitude of 58 mb−0 mb=58 mb, i.e., much greater than the amplitude created by the existing systems of roughly 58 mb−52 mb=6 mb amplitude pulsation. This leads to a significant increase in efficiency, creating a resonance inside the lungs, not simply a rush of air out of the lungs, creating thereby a shearing effect to pull mucus off the bronchial walls. The invention also allows creating the sheering effect and soliciting a cough much sooner than existing devices.

Furthermore, some of the features of the exemplary embodiments of this invention may be used to advantage without the corresponding use of other features. As such, the foregoing description should be considered as merely illustrative of the principles, teachings and embodiments of this invention, and not in limitation thereof.

1. Medical vest for High Frequency Chest Wall Oscillation (HFCWO) system, comprising at least a device comprising a deformable chamber and at least a port in communication with the chamber configured to let a pressurized fluid flowing alternatively in and out the chamber so that the inflatable device alternatively passes from an inflated configuration to a deflated configuration, characterized in that the device is configured to essentially expand along one single direction when passing from the deflated configuration to the inflated configuration and wherein the device comprises a body forming at least a part of the chamber, the body comprising bellows arranged for automatically decreasing the length of the body and bringing the device back to its deflated configuration when the chamber is not supplied with pressurized air.

2. Medical vest according to claim 1, wherein the device comprises a head operating repetitive back and forth movements and having an impact portion configured to transfer pulsations onto the body of the patient at each forth movement during usage and wherein the head and the body are made of a single part.

3. Medical vest according to claim 1, wherein the device comprises the body, a head configured to stroke the body of the patient during usage, and a base, the body extending between the base and the head, wherein the base comprises at least: an inlet port for feeding the chamber with pressurized fluid and at least an outlet port for communication between the chamber and a valve.

4. Medical vest according to claim 1, wherein the body is arranged to expand along said one single direction when the device passes from the deflated configuration to the inflated configuration.

5. Medical vest according to claim 4, wherein the body is arranged to expand according to a transverse direction that is substantially perpendicular to said one single direction and to retract along said single direction when the device passes from the inflated configuration to the deflated configuration.

6. Medical vest according to claim 5, wherein the expansion along said one single direction is higher than the expansion according to the transverse direction.

7. Medical vest according to claim 1, wherein the body comprises at least a wall forming the bellows, the thickness of the wall forming the bellows being comprised between 0.4 mm and 1.8 mm.

8. Medical vest according to claim 1, wherein the device comprises a head configured to stroke the body of the patient during usage, the body being substantially deformable along said one single direction and a base, the body extending between the base and the head, wherein the head is essentially not deformable in use and wherein the base is essentially not deformable in use.

9. Medical vest according to claim 8, wherein the base comprises the port and wherein the chamber is formed by the body, the head and the base.

10. Medical vest according to claim 8, wherein the head and the body are made of a single part made of silicon.

11. Medical vest according to claim 1, comprising a plurality of housings, at least some of the housing comprising a device.

12. Medical vest according to claim 11, wherein a housing has a first wall arranged to be in regard with the patient's body and a second wall arranged to be in regard with the outside during usage of the medical vest, the device comprising a head configured to be in contact with the first wall, a base configured to be in contact with the second wall and the body extending between the base and the head.

13. High Frequency Chest Wall Oscillation (HFCWO) system comprising a medical vest according to claim 1, and comprising means for delivering a pressurized fluid to the device.

14. High Frequency Chest Wall Oscillation (HFCWO) system according to claim 13, wherein at least some of the devices are independently provided with a pressurized fluid
